(19) United States
(12) Patent Application Publication
(10) Pub. No.: US 2024/0316658 A1
(43) Pub. Date: Sep. 26, 2024

(54) ULTRA-PRECISION MACHINING METHOD

(71) Applicant: Guangdong University of Technology, Guangzhou (CN)

(72) Inventors: Sujuan WANG, Guangzhou City (CN); Zhanwen SUN, Guangzhou City (CN); Zhenhong LU, Guangzhou City (CN); Xiaoyue ZHANG, Guangzhou City (CN)

(21) Appl. No.: 18/611,134

(22) Filed: Mar. 20, 2024

(30) Foreign Application Priority Data
Mar. 20, 2023 (CN) 202310275536.3

(51) Int. Cl. B23C 3/00

(52) U.S. Cl. CPC B23C 3/00

(57) ABSTRACT

The present disclosure discloses an ultra-precision machining method, including determining a total material removal amount based on a product to be machined and a blank, and performing rough machining to complete a material removal amount of the rough machining; after the rough machining, establishing an ultra-precision machining error prediction model by using an existing machining error, and predicting a semi-finishing error; re-establishing an ultra-precision machining error prediction model considering influence of the semi-finishing error; and finally performing finishing process planning. In the ultra-precision machining method according to the present disclosure, influence of the finishing error is considered, the ultra-precision machining error prediction model is re-established, and by integrated optimization of process parameters of the semi-finishing and the finishing, machining precision of ultra-precision machining is further improved without reducing machining efficiency.

### CROSS REFERENCE TO RELATED APPLICATION

This patent application claims the benefit and priority of Chinese Patent Application No. 2023102755363, filed with the China National Intellectual Property Administration on Mar. 20, 2023, the disclosure of which is incorporated by reference herein in its entirety as part of the present application.

### TECHNICAL FIELD

The present disclosure relates to the technical field of machining, and in particular, to an ultra-precision machining method.

### BACKGROUND

In the field of ultra-precision machining, in order to improve machining efficiency, machining steps fall into rough machining, semi-finishing, and finishing. The main flow is shown in FIG. 1. Currently, it is generally believed that final precision of a machined surface is determined by finishing, so in process planning of semi-finishing, only machining efficiency, that is, a large material removal amount, is considered.

For process planning of finishing, a machining precision prediction model is established usually by analyzing influencing factors of surface quality in finishing, and then process parameters of finishing, for example, a spindle speed, a feed speed, and the like in ultra-precision turning, and a spindle speed, a feed speed, a cutting spacing, and the like in ultra-precision milling, are optimized, so as to obtain products that meet precision requirements. In an existing ultra-precision machining error prediction model, only cutting tools, machining parameters and material properties of workpieces used in finishing are considered, while process planning of finishing only considers the influence of various process parameters on machining precision on the premise that a surface obtained by semi-finishing is smooth. In the prior art, it is neglected that a surface to be machined by finishing is left by semi-finishing, and also has surface roughness and shape errors, and the errors and machining parameters of finishing pertain to the micron level, which also affects machining quality of finishing.

Therefore, how to prevent accumulation of semi-finishing and finishing errors from affecting final machining precision during ultra-precision machining in the prior art has become an urgent problem to be solved by those skilled in the art.

### SUMMARY

An objective of the present disclosure is to provide an ultra-precision machining method, to solve the problems existing in the prior art and improve machining precision.

To achieve the above objective, the present disclosure provides the following solutions. The present disclosure provides an ultra-precision machining method, including the following steps:
step 1: determining a total material removal amount based on a product to be machined and a blank;
step 2: performing rough machining to complete a material removal amount of the rough machining;
step 3: establishing an ultra-precision machining error prediction model by using an existing machining error, and predicting a semi-finishing error;
step 4: re-establishing an ultra-precision machining error prediction model considering influence of the semi-finishing error; and
step 5: performing finishing process planning.

Preferably, in step 1, the total material removal amount is calculated based on geometric features of the blank, with a removed volume of Vₐₗₗ; in step 2, rough machining process planning is performed to complete the material removal amount of the rough machining, with a removed volume of Vᵣ;

in step 3, precision of the product to be machined is required to be Rᵣ, and the ultra-precision machining error prediction model R_{f}=f₁(T_{f},M_{f}) is established by using the existing machining error:

$${R}_{f} = \frac{{f}_{f}^{2}}{8 {r}_{ε , f}} , \qquad ( formula 1 )$$

where f_{f} is a feed amount of finishing; r_{ε,f} is an arc radius of a tip of a cutting tool used for the finishing; and

R_{f}<Rᵣ is set, preliminary planning of a finishing process is performed, and a material volume removal amount of the finishing is calculated, with a removed volume of V_{f}: V_{f}=f₂(T_{f},M_{f}), where T_{f} is the cutting tool for the finishing, and M_{f} is a machining parameter of the finishing.

Preferably, a material removal amount of semi-finishing is calculated, with a removed volume of Vₛ: Vₛ=Vₐₗₗ−Vᵣ−V_{f}.

Preferably, semi-finishing process planning is performed, and a cutting tool Tₛ and a processing parameter Mₛ of the semi-finishing are determined; and

a semi-finishing error Rₛ=f₁(Tₛ,Mₛ) is predicted based on existing ultra-precision machining quality and the ultra-precision machining error prediction model R_{f}=f₁(T_{f},M_{f}).

Preferably, in step 4, a surface to be subjected to semi-finishing is discretized into i cutting tool location points, and an instantaneous cutting thickness tᵢ during the finishing based on the influence of the semi-finishing error and a calculation process thereof are as follows:

$${Z}_{s} ( i ) = - {A}_{s} \vert sin ( \frac{π \cdot i \cdot Δ {l}_{p}}{{f}_{s}} ) \vert + {A}_{s} , \qquad ( formula 2 )$$

$${A}_{s} = \{ \begin{matrix}{R}_{s} , {f}_{s} < {w}_{s} \\ {t}_{s} , {f}_{s} \geq {w}_{s}\end{matrix} , and \qquad ( formula 3 )$$

$${w}_{s} = 2 \sqrt{{r}_{ε , s}^{2} - {( {r}_{ε , s} - {t}_{s} )}^{2}} , \qquad ( formula 4 )$$

where Zₛ(i) is a scallop height corresponding to an i^{th} cutting tool location point in the semi-finishing; Aₛ is a maximum scallop height left by the semi-finishing; r_{ε,s} is an arc radius of a tip of the cutting tool used for the semi-finishing; fₛ is a feed amount of the semi-finishing, and is equal to a cycle length between two cutting tool paths; wₛ is a cutting width of the semi-finishing; tₛ is a nominal cutting depth of the semi-finishing; Δlₚ is a horizontal distance between adjacent cutting tool location points, that is, a length of a discrete unit; and t_{f}(i) is the instantaneous cutting thickness of the i^{th} cutting tool location point during the finishing:

$${t}_{f} ( i ) = {Z}_{s} ( i ) + {t}_{o} . \qquad ( formula 5 )$$

Preferably, the ultra-precision machining error prediction model R_{f}=f(T_{f},M_{f},Pₘ,Rₛ) is re-established:

$${R}_{f} = {f}_{2} ( {T}_{f} , {M}_{f} , {P}_{m} , {R}_{s} ) = {k}_{3} [ \frac{{f}_{f}^{2}}{8 {r}_{ε , f}} + \frac{{h}_{Dm i n}}{2} ( 1 + \frac{{r}_{ε , f} {h}_{Dm i n}}{2} ) + {k}_{1} \frac{H}{E} {r}_{n , f} {k}_{2} + {k}_{4} \frac{H}{E} Δ {S}_{s}^{{n}_{s}} ] , \qquad ( formula 6 )$$

where f_{f} is the feed amount of the finishing; r_{ε,f} is the arc radius of the tip of the cutting tool used for the finishing; r_{n,f} is a cutting edge radius of the cutting tool used for the finishing; h_{Dmin} is a minimum cutting thickness; H is hardness of a material; E is an elastic modulus of the material; k₁ denotes influence of an arc radius and a rake angle of a cutting tool tip on elastic springback; k₂ denotes influence of the minimum cutting thickness on a “size effect” generated during cutting; k₃ denotes influence of a plastic lateral flow; k₄ is a proportionality coefficient of the semi-finishing error; and ΔSₛ is a dynamically changing interference area during the finishing caused by the semi-finishing error, and is equal to a sum of Zₛ(i) in a maximum cutting range w_{max,f}=2\sqrt{r_{ε,s}²−(r_{ε,s}−Aₛ−tₒ)²} when the cutting tool is at the i^{th} cutting tool location point during the finishing.

Preferably, in step 5, the finishing process planning is performed based on the precision of the product to be machined that is required to be Rᵣ and the ultra-precision machining error prediction model re-established in step 5, and the finishing cutting tool T_{f} and the finishing parameter M_{f} are determined to meet the following condition:

$$\{ \begin{matrix}{R}_{f} ( {T}_{f} , {M}_{f} , {P}_{m} , {T}_{s} , {M}_{s} ) \leq {R}_{r} \\ {V}_{f} \leq {V}_{all} - {V}_{r} - {V}_{s}\end{matrix} . \qquad ( formula 7 )$$

Preferably, before step 1, an ultra-precision machining method is selected based on the product to be machined.

Compared with the prior art, the present disclosure has the following technical effects: the ultra-precision machining method according to the present disclosure includes first determining a total material removal amount based on a product to be machined and a blank, and performing rough machining to complete a material removal amount of the rough machining; after the rough machining, establishing an ultra-precision machining error prediction model by using an existing machining error, and predicting a semi-finishing error; then re-establishing an ultra-precision machining error prediction model considering influence of the semi-finishing error; and finally performing finishing process planning. In the ultra-precision machining method according to the present disclosure, influence of the finishing error is considered, the ultra-precision machining error prediction model is re-established, and by integrated optimization of process parameters of the semi-finishing and the finishing, machining precision of ultra-precision machining is further improved without reducing machining efficiency.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic flowchart of an ultra-precision machining method in the prior art;

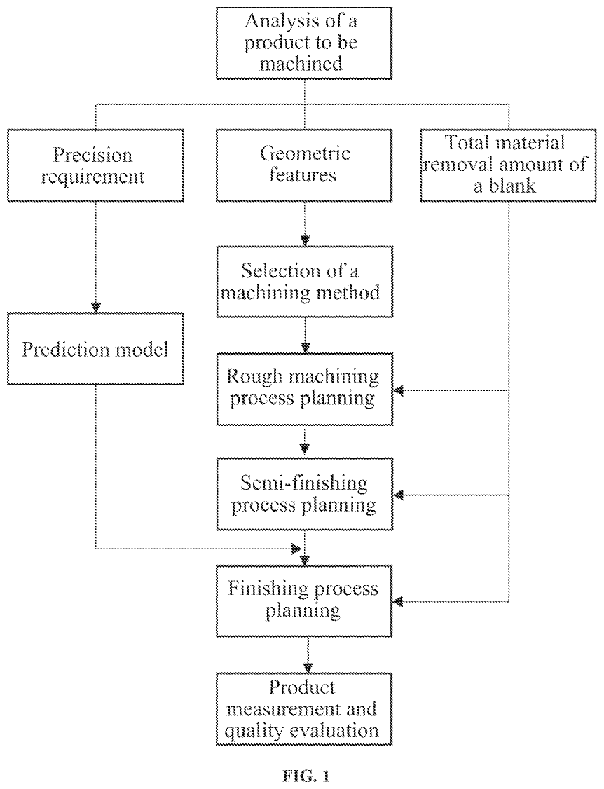

FIG. 2 is a schematic flowchart of an ultra-precision machining method according to the present disclosure;

FIG. 3 is a schematic diagram of a morphology of a surface to be subjected to semi-finishing in an ultra-precision machining method according to Embodiment 1 of the present disclosure;

FIG. 4 is a schematic diagram of a finishing cutting interference area in the ultra-precision machining method according to Embodiment 1 of the present disclosure;

FIG. 5 is a variation curve graph of a dynamically changing interference area in an ultra-precision machining method according to Embodiment 2 of the present disclosure; and

FIG. 6 is a diagram showing a comparison between experimental results and predicted results in the ultra-precision machining method according to Embodiment 2 of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those skilled in the art based on the embodiments of the present disclosure without creative efforts shall fall within the protection scope of the present disclosure.

An objective of the present disclosure is to provide an ultra-precision machining method, to solve the problems existing in the prior art and improve machining precision.

In order to make the above objective, features and advantages of the present disclosure clearer and more comprehensible, the present disclosure will be further described in detail below in combination with accompanying drawings and specific implementations.

The present disclosure provides an ultra-precision machining method, including the following steps.
Step 1: Determine a total material removal amount based on a product to be machined and a blank.
Step 2: Perform rough machining to complete a material removal amount of the rough machining.
Step 3: Establish an ultra-precision machining error prediction model by using an existing machining error, and predict a semi-finishing error.
Step 4: Re-establish an ultra-precision machining error prediction model considering influence of the semi-finishing error.
Step 5: Perform finishing process planning.

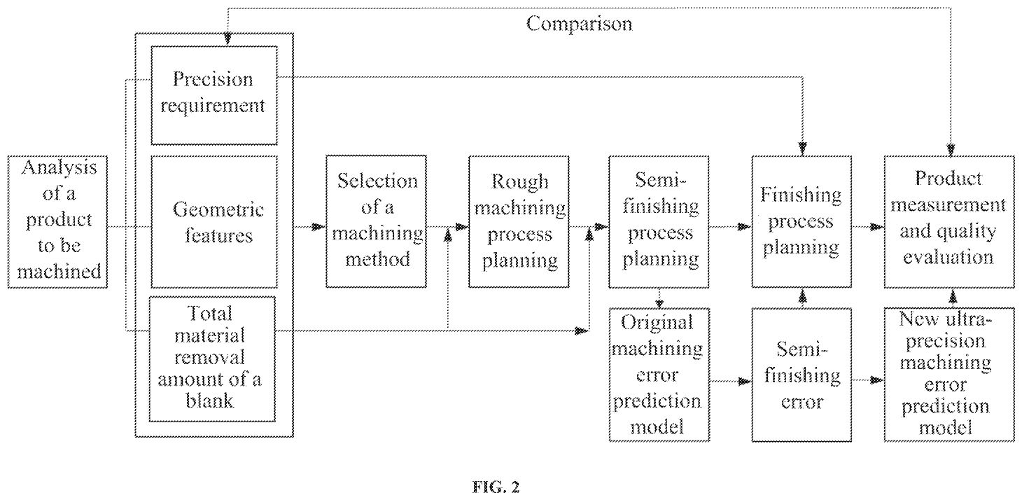

The ultra-precision machining method according to the present disclosure includes first determining the total material removal amount based on the product to be machined and the blank, and performing rough machining to complete the material removal amount of the rough machining; after the rough machining, establishing the ultra-precision machining error prediction model by using the existing machining error, and predicting the semi-finishing error; then re-establishing the ultra-precision machining error prediction model based on the semi-finishing error; and finally performing finishing process planning. A specific process is shown in FIG. 2. In the ultra-precision machining method according to the present disclosure, influence of the finishing error is considered, the ultra-precision machining error prediction model is re-established, and by integrated optimization of process parameters of the semi-finishing and the finishing, machining precision of ultra-precision machining is improved.

The ultra-precision machining method according to the present disclosure is further explained below in conjunction with specific embodiments.

### Embodiment 1

An ultra-precision machining method according to this embodiment includes method the following steps.

S1: Select an ultra-precision machining method based on a product to be machined. For example, single-point diamond turning may be selected for machining of a product with a spherical surface, a cylindrical surface or other rotationally symmetric features, and milling may be selected for a non-rotationally symmetric free-form surface and microstructure array.

S2: Calculate a total material removal amount based on geometric features of a blank, with a removed volume of Vₐₗₗ.

S3: Perform rough machining process planning, aiming at establishing a relative coordinate system between a workpiece to be machined and an ultra-precision machine tool, and complete a material removal amount of rough machining, with a removed volume of Vᵣ.

Step 4: Perform finishing process planning.

First, precision of the product to be machined is required to be Rᵣ, and an ultra-precision machining error prediction model R_{f}=f₁(T_{f},M_{f}) is established by using an existing machining error:

$${R}_{f} = \frac{{f}_{f}^{2}}{8 {r}_{ε , f}} , \qquad ( formula 1 )$$

where f_{f} is a feed amount of finishing; r_{ε,f} is an arc radius of a tip of a cutting tool used for the finishing; and

R_{f}<Rᵣ is set, preliminary planning of a finishing process is performed, and a material volume removal amount of the finishing is calculated, with a removed volume of V_{f}: V_{f}=f₂(T_{f},M_{f}), where T_{f} is the cutting tool for the finishing, and M_{f} is a machining parameter of the finishing.

Then, a material removal amount of semi-finishing is calculated, with a removed volume of Vₛ: Vₛ=Vₐₗₗ−Vᵣ−V_{f}.

Finally, semi-finishing process planning is performed, and a cutting tool Tₛ and a processing parameter Mₛ of the semi-finishing are determined; and

a semi-finishing error Rₛ=f₁(Tₛ,Mₛ), including shape precision and surface roughness, is predicted based on existing ultra-precision machining quality and the ultra-precision machining error prediction model R_{f}=f₁(T_{f},M_{f}), and a three-dimensional micro-morphology mode of a surface subjected to semi-finishing is simulated.

It should also be noted that in the semi-finishing process planning in the prior art, the large material volume removal amount Vₛ should be ensured, and geometric features of the blank should be as close as possible to geometric features of a required product, and the latter requirement may reduce efficiency of ultra-precision machining. However, according to the present disclosure, by optimization of process parameters of the semi-finishing, machining precision of ultra-precision machining is improved without reducing machining efficiency.

Step 5: Re-establish an ultra-precision machining error prediction model considering influence of the semi-finishing error.

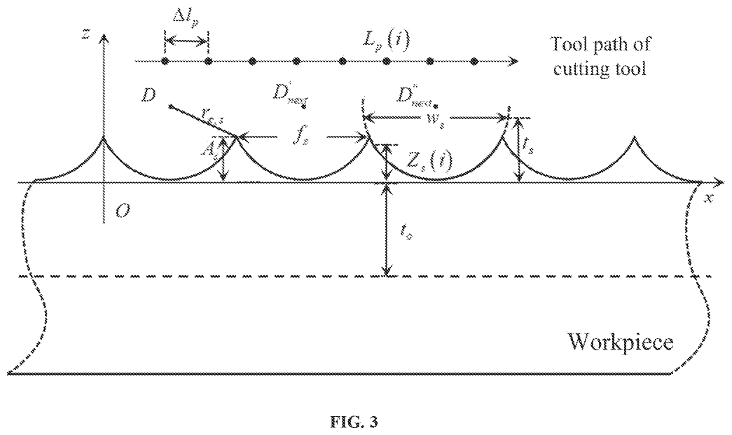

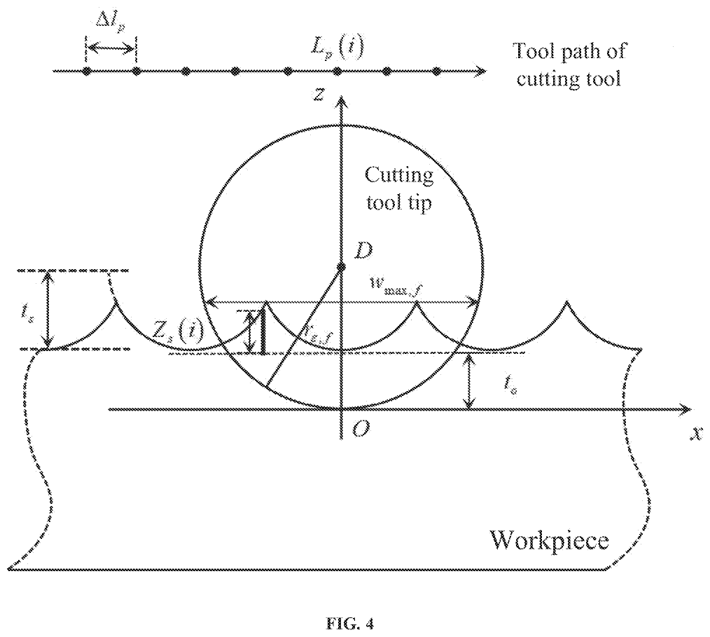

First, due to the existence of the semi-finishing error, a surface subjected to finishing is non-smooth, which makes a cutting depth of the finishing change dynamically instead of being constant. The change in cutting depth may affect the removal process of a micron-sized material and change a material removal mechanism, thus affecting a surface generation mechanism and surface quality. A morphology of a surface to be subjected to semi-finishing is shown in FIG. 3. The surface to be subjected to semi-finishing is discretized into i cutting tool location points, and an instantaneous cutting thickness tᵢ during the finishing based on the influence of the semi-finishing error and a calculation process thereof are as follows:

$${Z}_{s} ( i ) = - {A}_{s} \vert sin ( \frac{π \cdot i \cdot Δ {l}_{p}}{{f}_{s}} ) \vert + {A}_{s} , \qquad ( formula 2 )$$

$${A}_{s} = \{ \begin{matrix}{R}_{s} , & {f}_{s} < {w}_{s} \\ {t}_{s} , & {f}_{s} \geq {w}_{s}\end{matrix} , and \qquad ( formula 3 )$$

$${w}_{s} = 2 \sqrt{{r}_{ε , s}^{2} - {( {r}_{ε , s} - {t}_{s} )}^{2}} , \qquad ( formula 4 )$$

where Zₛ(i) is a scallop height corresponding to an i^{th} cutting tool location point in the semi-finishing; Aₛ is a maximum scallop height left by the semi-finishing; r_{ε,s} is an arc radius of a tip of the cutting tool used for the semi-finishing; fₛ is a feed amount of the semi-finishing, and is equal to a cycle length between two cutting tool paths; wₛ is a cutting width of the semi-finishing; tₛ is a nominal cutting depth of the semi-finishing (which is specifically a nominal cutting depth used in semi-finishing to form a morphology subjected to semi-finishing, with details shown in FIG. 4); Δlₚ is a horizontal distance between adjacent cutting tool location points, that is, a length of a discrete unit; and t_{f}(i) is the instantaneous cutting thickness of the i^{th} cutting tool location point during the finishing:

$${t}_{f} ( i ) = {Z}_{s} ( i ) + {t}_{o} . \qquad ( formula 5 )$$

Based on the ultra-precision machining error prediction model R_{f}=f₁(T_{f},M_{f}) in S4, the influence of the semi-finishing error and the dynamic change in instantaneous chip thickness are introduced, and the ultra-precision machining error prediction model R_{f}=f(T_{f},M_{f},Pₘ,Rₛ) is re-established, that is, the ultra-precision machining error R_{f} is expressed as a function of a finishing parameter and cutting tool, workpiece material properties and the semi-finishing error:

$${R}_{f} = {f}_{2} ( {T}_{f} , {M}_{f} , {P}_{m} , {R}_{s} ) = {k}_{3} [ \frac{{f}_{f}^{2}}{8 {r}_{ε , f}} + \frac{{h}_{Dm i n}}{2} ( 1 + \frac{{r}_{ε , f} {h}_{Dm i n}}{2} ) + {k}_{1} \frac{H}{E} {r}_{n , f} {k}_{2} + {k}_{4} \frac{H}{E} Δ {S}_{s}^{{n}_{s}} ] , \qquad ( formula 6 )$$

where f_{f} is the feed amount of the finishing; r_{ε,f} is the arc radius of the tip of the cutting tool used for the finishing; r_{n,f} is a cutting edge radius of the cutting tool used for the finishing; h_{Dmin} is a minimum cutting thickness; H is hardness of a material; E is an elastic modulus of the material; k₁ denotes influence of an arc radius and a rake angle of a cutting tool tip on elastic springback; k₂ denotes influence of the minimum cutting thickness on a “size effect” generated during cutting; k₃ denotes influence of a plastic lateral flow; k₄ is a proportionality coefficient of the semi-finishing error; and ΔSₛ is a dynamically changing interference area during the finishing caused by the semi-finishing error, and is equal to a sum of Zₛ(i) in a maximum cutting range w_{max,f}=2\sqrt{r_{ε,s}²−(r_{ε,s}−Aₛ−tₒ)²} when the cutting tool is at the i^{th} cutting tool location point during the finishing, as shown in FIG. 4.

Step 6: Perform the finishing process planning based on the precision of the product to be machined that is required to be Rᵣ and the ultra-precision machining error prediction model R_{f}=f(T_{f},M_{f},Pₘ,Rₛ) re-established in step S5, and determine the finishing cutting tool T_{f} and the finishing parameter M_{f} to meet the following condition:

$$\{ \begin{matrix}{R}_{f} ( {T}_{f} , {M}_{f} , {P}_{m} , {T}_{s} , {M}_{s} ) \leq {R}_{r} \\ {V}_{f} \leq {V}_{all} - {V}_{r} - {V}_{s}\end{matrix} . \qquad ( formula 7 )$$

### Embodiment 2

Semi-finishing parameters were obtained by using an ultra-precision machining method according to this embodiment:

Feed amount of semi-finishing: fₛ=180 μm

Arc radius of a tip of a semi-finishing cutting tool: r_{ε,s}=2044 μm

Cutting depth of semi-finishing: tₛ=3 μm

Theoretical scallop height of radius machining: Aₛ=1.98 μm

Finishing was an orthogonal cutting experiment with parameters as follows:

Nominal cutting depth of finishing: tₒ=3 μm

Arc radius of a tip of a finishing cutting tool: r_{ε,s}=2044 μm

A workpiece was made of RSA 6061:

Hardness H=1.585 GPa

Elastic modulus E=88.203 GPa

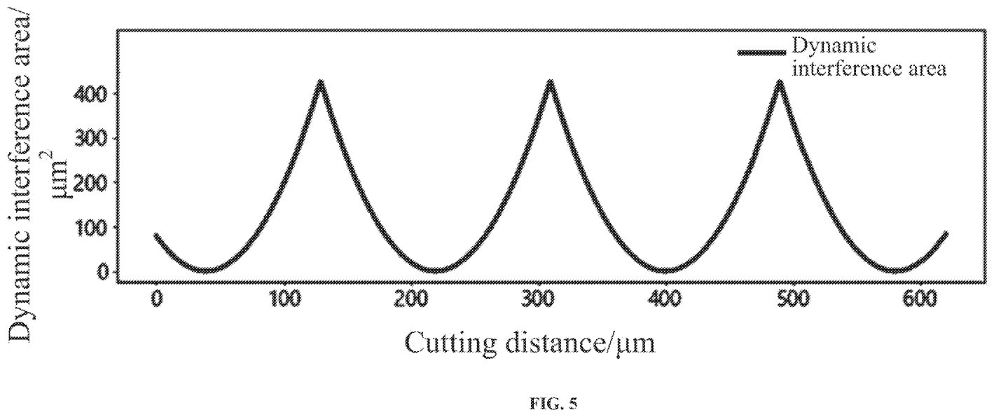

By calculation, with a change in cutting tool location point, a dynamically changing interference area ΔSₛ is shown in FIG. 5.

A curve graph of a comparison between a semi-finishing error

$$Δ {R}_{s} = {k}_{4} \frac{H}{E} Δ {S}_{s}^{{n}_{s}}$$

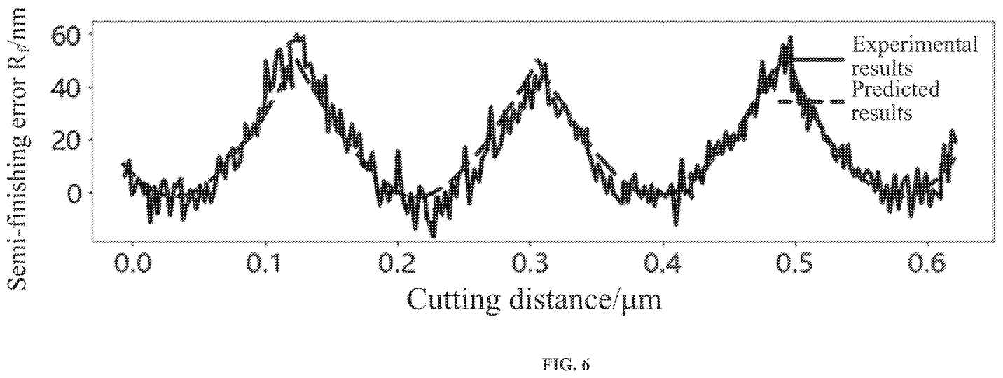

and experimental results is shown in FIG. 6.

Integrated optimization of process parameters of the finishing and the semi-finishing was performed by using the ultra-precision machining method according to the present disclosure, so that machining precision of ultra-precision machining can be improved without affecting machining efficiency.

Specific examples are used for illustration of the principles and implementations of the present disclosure. The description of the above embodiments is merely used to help understand the method and its core ideas of the present disclosure. In addition, those of ordinary skill in the art can make modifications in terms of specific implementations and scope of use according to the ideas of the present disclosure. In conclusion, the content of this description shall not be construed as limitations to the present disclosure.

What is claimed is:

1. An ultra-precision machining method, comprising the following steps:
step 1: determining a total material removal amount based on a product to be machined and a blank;
step 2: performing rough machining to complete a material removal amount of the rough machining;
step 3: establishing an ultra-precision machining error prediction model by using an existing machining error, and predicting a semi-finishing error;
step 4: re-establishing an ultra-precision machining error prediction model considering influence of the semi-finishing error; and
step 5: performing finishing process planning.

2. The ultra-precision machining method according to claim 1, wherein
in step 1, the total material removal amount is calculated based on geometric features of the blank, with a removed volume of Vₐₗₗ; in step 2, rough machining process planning is performed to complete the material removal amount of the rough machining, with a removed volume of Vᵣ;
in step 3, precision of the product to be machined is required to be Rᵣ, and the ultra-precision machining error prediction model R_{f}=f₁(T_{f},M_{f}) is established by using the existing machining error:
$${R}_{f} = \frac{{f}_{f}^{2}}{8 {r}_{ε , f}} , \qquad ( formula 1 )$$
wherein f_{f} is a feed amount of finishing; r_{ε,f} is an arc radius of a tip of a cutting tool used for the finishing; and
R_{f}<Rᵣ is set, preliminary planning of a finishing process is performed, and a material volume removal amount of the finishing is calculated, with a removed volume of V_{f}: V_{f}=f₂(T_{f},M_{f}), wherein T_{f} is the cutting tool for the finishing, and M_{f} is a machining parameter of the finishing.

3. The ultra-precision machining method according to claim 2, wherein
a material removal amount of semi-finishing is calculated, with a removed volume of Vₛ:
$${V}_{s} = {V}_{a l l} - {V}_{r} - {V}_{f} .$$

4. The ultra-precision machining method according to claim 3, wherein
semi-finishing process planning is performed, and a cutting tool Tₛ and a processing parameter Mₛ of the semi-finishing are determined; and
a semi-finishing error Rₛ=f₁(Tₛ,Mₛ) is predicted based on existing ultra-precision machining quality and the ultra-precision machining error prediction model R_{f}=f₁(T_{f},M_{f}).

5. The ultra-precision machining method according to claim 4, wherein
in step 4, a surface to be subjected to semi-finishing is discretized into i cutting tool location points, and an instantaneous cutting thickness tᵢ during the finishing based on the influence of the semi-finishing error and a calculation process thereof are as follows:
$${Z}_{s} ( i ) = - {A}_{s} \vert sin ( \frac{π \cdot i \cdot Δ {l}_{p}}{{f}_{s}} ) \vert + {A}_{s} , \qquad ( formula 2 )$$
$${A}_{s} = \{ \begin{matrix}{R}_{s} , & {f}_{s} < {w}_{s} \\ {t}_{s} , & {f}_{s} \geq {w}_{s}\end{matrix} , and \qquad ( formula 3 )$$
$${w}_{s} = 2 \sqrt{{r}_{ε , s}^{2} - {( {r}_{ε , s} - {t}_{s} )}^{2}} , \qquad ( formula 4 )$$
wherein Zₛ(i) is a scallop height corresponding to an i^{th} cutting tool location point in the semi-finishing; Aₛ is a maximum scallop height left by the semi-finishing; r_{ε,s} is an arc radius of a tip of the cutting tool used for the semi-finishing; fₛ is a feed amount of the semi-finishing, and is equal to a cycle length between two cutting tool paths; wₛ is a cutting width of the semi-finishing; tₛ is a nominal cutting depth of the semi-finishing; Δlₚ is a horizontal distance between adjacent cutting tool location points, that is, a length of a discrete unit; and t_{f}(i) is the instantaneous cutting thickness of the i^{th} cutting tool location point during the finishing:
$${t}_{f} ( i ) = {Z}_{s} ( i ) + {t}_{o} . \qquad ( formula 5 )$$

6. The ultra-precision machining method according to claim 5, wherein
the ultra-precision machining error prediction model R_{f}=f(T_{f},M_{f},Pₘ,Rₛ) is re-established:
$${R}_{f} = {f}_{2} ( {T}_{f} , {M}_{f} , {P}_{m} , {R}_{s} ) = {k}_{3} [ \frac{{f}_{f}^{2}}{8 {r}_{ε , f}} + \frac{{h}_{Dm i n}}{2} ( 1 + \frac{{r}_{ε , f} {h}_{Dm i n}}{2} ) + {k}_{1} \frac{H}{E} {r}_{n , f} {k}_{2} + {k}_{4} \frac{H}{E} Δ {S}_{s}^{{n}_{s}} ] , \qquad ( formula 6 )$$
wherein f_{f} is the feed amount of the finishing; r_{ε,f} is the arc radius of the tip of the cutting tool used for the finishing; r_{n,f} is a cutting edge radius of the cutting tool used for the finishing; h_{Dmin} is a minimum cutting thickness; H is hardness of a material; E is an elastic modulus of the material; k₁ denotes influence of an arc radius and a rake angle of a cutting tool tip on elastic springback; k₂ denotes influence of the minimum cutting thickness on a “size effect” generated during cutting; k₃ denotes influence of a plastic lateral flow; k₄ is a proportionality coefficient of the semi-finishing error; and ΔSₛ is a dynamically changing interference area during the finishing caused by the semi-finishing error, and is equal to a sum of Zₛ(i) in a maximum cutting range w_{max,f}=2\sqrt{r_{ε,s}²−(r_{ε,s}−Aₛ−tₒ)²} when the cutting tool is at the i^{th} cutting tool location point during the finishing.

7. The ultra-precision machining method according to claim 6, wherein
in step 5, the finishing process planning is performed based on the precision of the product to be machined that is required to be Rᵣ and the ultra-precision machining error prediction model re-established in step 5, and the finishing cutting tool T_{f} and the finishing parameter M_{f} are determined to meet the following condition:
$$\{ \begin{matrix}{R}_{f} ( {T}_{f} , {M}_{f} , {P}_{m} , {T}_{s} , {M}_{s} ) \leq {R}_{r} \\ {V}_{f} \leq {V}_{all} - {V}_{r} - {V}_{s}\end{matrix} . \qquad ( formula 7 )$$

8. The ultra-precision machining method according to claim 1, wherein before step 1, an ultra-precision machining method is selected based on the product to be machined.
